(19) United States
(12) Patent Application Publication
(10) Pub. No.: US 2018/0218640 A1
(43) Pub. Date: Aug. 2, 2018

(54) User Interfaces for Fleet Management

(71) Applicant: Bassam Alkassar, Plano, TX (US)

(72) Inventor: Bassam Alkassar, Plano, TX (US)

(21) Appl. No.: 15/881,733

(22) Filed: Jan. 27, 2018

Related U.S. Application Data
(60) Provisional application No. 62/451,375, filed on Jan. 27, 2017.

(51) Int. Cl. G09B 19/16; G06F 21/34; G09B 5/06

(52) U.S. Cl. CPC G09B 19/167; G06T 13/40; G09B 5/065; G06F 21/34

(57) ABSTRACT

A method and system for managing a vehicle fleet using information obtained from a road safety profile based on actual driving performance. The road safety profile is used to alert and educate the driver about safe driving requirements. The system presents a graphical user interface for displaying a driver's score and road safety profile based on actual driving performance for each driver based on his results according to a FMS Driver Merit System (DMS) calculation.

### BACKGROUND OF THE INVENTION

### Technical Field

The present invention relates generally to an interactive system for providing graphical feedback to drivers, and, more particularly, to a graphical user interface for displaying monitored driver activity for improving driver behavior and safety.

### SUMMARY OF THE INVENTION

It is to be understood that both the general and detailed descriptions that follow are exemplary and explanatory only and are not restrictive of the invention.

The present invention provides an innovative graphical user interface (GUI) displayed on a presentation station connected to a fleet management portal for reporting a driver's safety driving habits while driving an employer's commercial vehicle. According to a first aspect, drivers can access their individual report using their own personalized RFID access card. According to a second aspect, each driver's history is analyzed according to a Driver Merit System (DMS) calculation. According to a third aspect, the GUI communicates performance results to each driver in their native language. According to a fourth aspect, at the end of an information presentation session, the presentation station will print a receipt for the driver with a total number of points the driver earned during said session and the maximum allowable points they could have earned under the DMS calculation framework.

Additional aspects and advantages of the invention will be set forth in part in the description which follows and, in part, will be obvious from the description, or may be learned by practice of the invention.

### BRIEF DESCRIPTION OF THE DRAWINGS

The accompanying figures further illustrate the present invention. The components in the drawings are not necessarily drawn to scale, emphasis instead being placed upon clearly illustrating the principles of the present invention. In the drawings, like reference numerals designate corresponding parts throughout the several views.

### BRIEF DESCRIPTION OF THE SEVERAL VIEWS OF THE DRAWINGS

These and other aspects and advantages of the present invention will become apparent and more readily appreciated from the following description of the embodiments, taken in conjunction with the accompanying drawings of which:

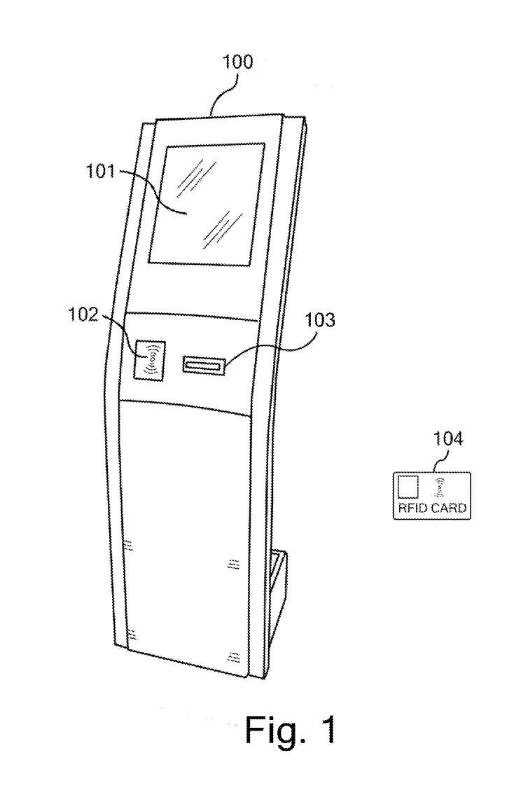

FIG. 1 shows of an exemplary presentation station for conducting an information presentation session in accordance with an embodiment of the invention.

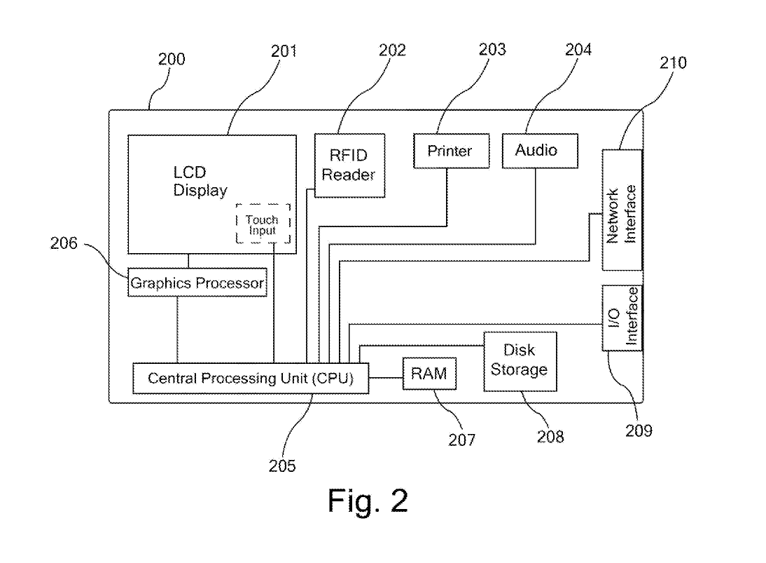

FIG. 2 is a block diagram of exemplary hardware for a presentation station consistent with the present invention.

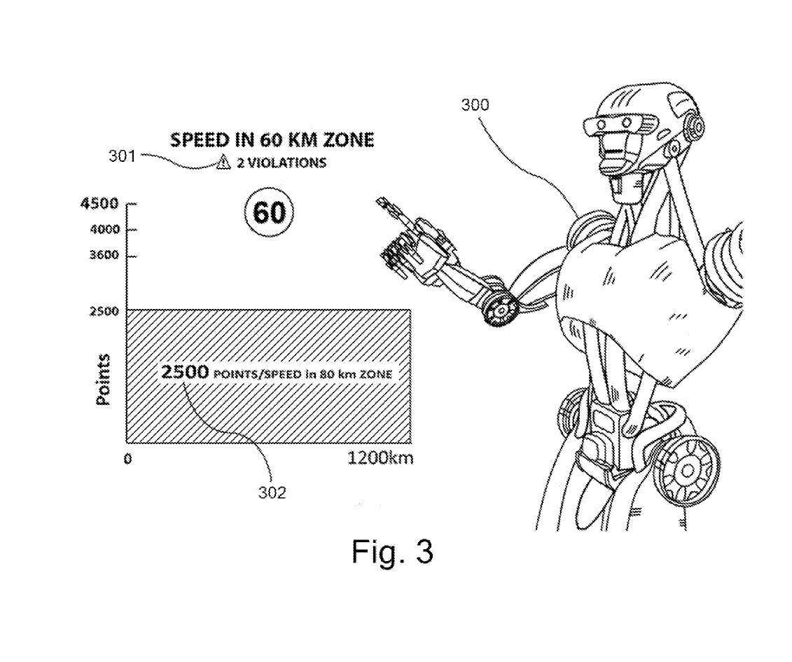

FIG. 3 shows the Graphical User Interface of an information presentation session including a violations report, in accordance with an embodiment of the invention.

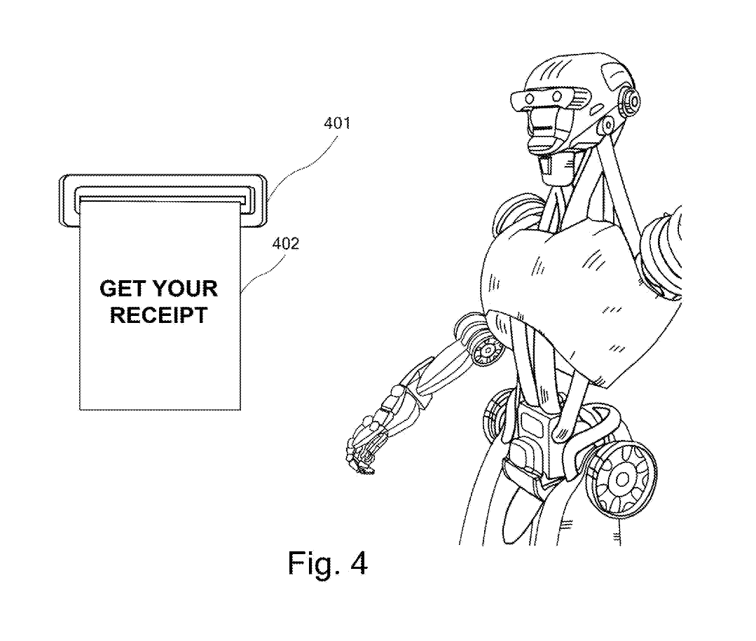

FIG. 4 shows the Graphical User Interface of the conclusion of an information presentation session indicating a report has been printed in accordance with an embodiment of the invention.

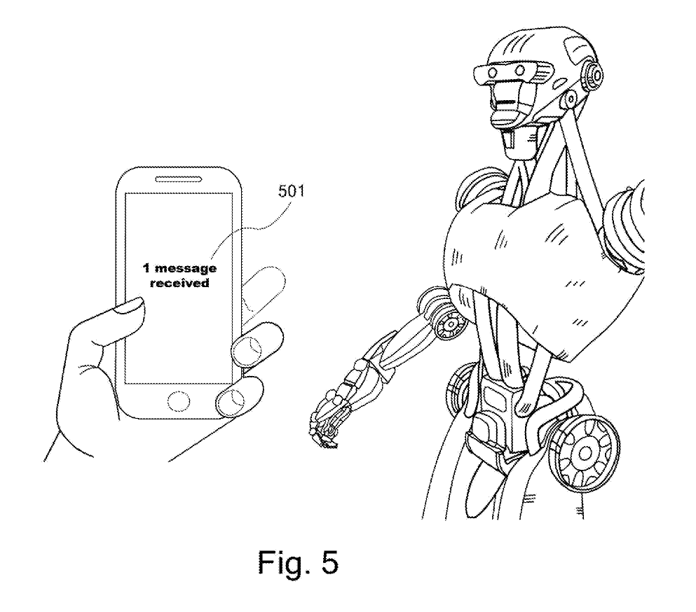

FIG. 5 shows the Graphical User Interface information presentation session indicating a mobile TXT/SMS message alert designation in accordance with an embodiment of the invention

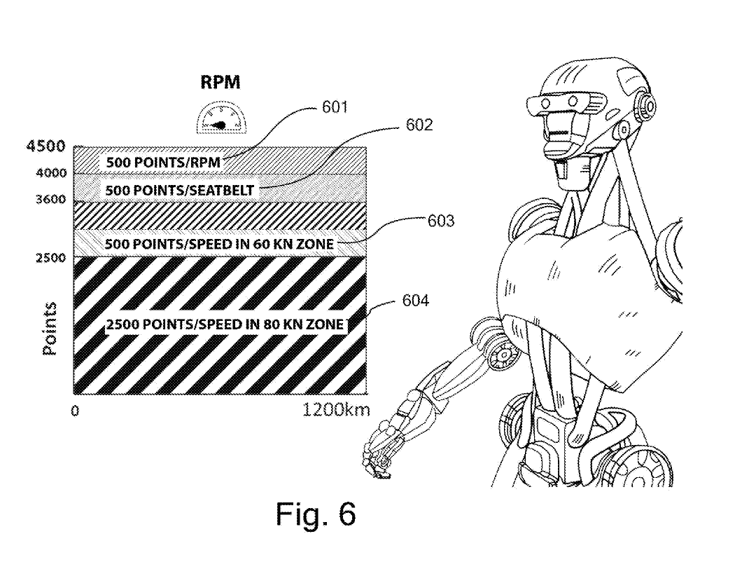

FIG. 6 shows the Graphical User Interface of an information presentation session demonstrating point totals in accordance with an embodiment of the invention.

### DETAILED DESCRIPTION OF THE INVENTION

Referring first to FIG. 1, the presentation station 100 provides each driver with feedback in the form of an information presentation session that is designed to improve and reinforce road safety awareness. An enrolled driver can access their individual report by authenticating themselves. In one embodiment, presentation station 100 includes a RFID sensor 102 for allowing drivers to authenticate using a personalized RFID access card 104. Alternatively, other types of authentication methods could be used such as, a biometric fingerprint reader or another biometric scan, such as retinal scan and the like. Other examples, include a USB dongle or electromagnetically encoded card key. Presentation station 100 further comprises a touch screen 101, allowing a driver to view and interact with an information presentation session and a printer 103. At the end of an information presentation session a driver report can be printed from the printer 103.

FIG. 2 shows block diagram of an exemplary hardware 200 for a presentation station 100 consistent with the present invention. Although referred to hereinafter as a “presentation station” it should be appreciated this term may also include other suitable programmable electronic devices consistent with the present invention. The hardware 200 typically includes at least one processor 205 (e.g., I3 4170 3.7G) coupled to a memory 207 (e.g., a DDR3 Kingston® 8 GB ST500G).

The hardware 200 may include one or more mass storage devices 208, e.g., a hard disk drive, an optical drive (e.g., a CD drive, a DVD drive, etc.), and/or a solid-state drive, among others. The mass storage device 208 may further include the operating system (e.g., Microsoft Windows® version 10). The hardware environment may further include a RFID reader 202 (e.g., a FMS Tech ISO™ dual chip card reader) for authenticating and/or identifying the specific driver to interact with. An audio system including (an audio speaker) 204 is provided for communicating information session content. The hardware 200 furthers includes a touch sensitive liquid crystal display (LCD) screen 201. An onboard discrete graphics display card as graphics processor 206 may be included for rendering the graphical user interface of information sessions. For example, the screen could be a 17-inch touch screen with a 1280×1024 pixel resolution.

Hardware 200 also may communicate information externally. For example, it may be coupled to one or more computers (e.g., a desktop or PC-based computer, workstations, a PC-based server, a minicomputer, a mainframe computer, etc.) through network interface 210, or may be a stand-alone device in the alternative. For example, network interface 210 communicate on a local-area network (LAN), a wide-area network (WAN), a wireless network, and/or a public network (e.g., the Internet). A printer 203 may be included for printing a summary of the information session for the driver. Printer types may include, for example, dot-matrix, laser, thermal, or the like. Hardware 200 may include a general wired and/or wireless communication port. For example, I/O interface 209 may represent a serial port (e.g., a RS-232 interface, a RS-422 interface, a RS-423 interface, or a universal serial bus (USB) port, etc.), a parallel port, a modem port, or a wireless port (e.g., an infrared port, radio frequency (RF) port, etc.).

Referring to FIG. 3, a GUI of the information presentation session includes a FMS Robot 300 for interacting with the driver. The FMS Agent 300 is programmed to address the driver by name. In some embodiments, FMS Agent 300 is preconfigured to speak the driver's own native language. The Graphical User Interface displays visual information in the form of feedback 301 covering the time period since the last information presentation session. FMS Robot 300 uses gestures to assist and inform the driver of each instance of unsafe behavior.

The FMS Robot 300 uses a merit point system as the basis for its information display. The FMS Robot 300 will highlight to the driver in every information presentation session their driving performance and their result in the session according to the several parameter, performance, and violation criteria. For example:

1. Total distance driven

2. Duration of over speeding violation in each speed zone

3. Duration of seatbelt compliance

4. Over revving occurrence

5. Number of night driving occurrence

6. Number of harsh braking occurrence

7. Number of harsh acceleration occurrences

The FMS Robot 300 will inform the driver how to increase their safety points and avoid losing points in a friendly manner. The FMS Robot 300 will reward drivers for their good driving and deduct points from those who keeps committing violations in their driving and not adhering to company road safety policy.

The following equation shows a basic score formula that the FMS robot 300 will calculate for

$$Score = ( \frac{Acceleration Occ}{\begin{matrix}Total Distance \\ Driven\end{matrix}} ) * 100 + ( \frac{Deceleration Occ}{\begin{matrix}Total Distance \\ Driven\end{matrix}} ) * 100 + ( \frac{Over revving Occ}{\begin{matrix}Total Distance \\ Driven\end{matrix}} ) * 100 + ( \frac{\begin{matrix}Seat Belt \\ Duration\end{matrix}}{\frac{10}{\begin{matrix}Total Distance \\ Driven\end{matrix}}} ) * 100 + ( \frac{\begin{matrix}Over Speed \\ Duration\end{matrix}}{\frac{10}{\begin{matrix}Total Distance \\ Driven\end{matrix}}} ) * 100$$

Additionally, one point for each 10-hours driving is added to each positive score.

The entire feedback session typically does not take more than 10 minutes. As seen in FIG. 4, at end of the information presentation session, the GUI will visually indicate to get a driving report receipt 402 from the presentation station 100 printer port 401. The presentation station 100 will print the score and loyalty points the driver gained in this session.

The information presentation session may be generated on a fixed time schedule or may be generated on demand, for example by a fleet manager. Restrictions may be imposed upon the driver for failure to complete a required information presentation session. Examples of restrictions may vary from, the deactivation of vehicle ignition systems to loss of monetary entitlement, and/or other privileges. Normally, a driver will sustain point deductions if he does not attend a scheduled or required information presentation session.

The preferred embodiment of the present invention is described herein in the context of a presentation station 100, but is not limited thereto.

What is claimed:

1. An article comprising a non-transitory machine-readable medium that stores a program, the program being executable by a presentation station having a graphical display device to provide visual feedback to assist and inform a vehicle operator about instances of safe and unsafe driving behavior comprising:
program code to receive data generated during operation of said vehicle and, in response, to generate and store values representing driving safety status information, wherein said values are weighted in proportion to the total distance driven during said operation of said vehicle; and
program code to convert said values to control signals that drive a visual infographic displayed graphically on said graphical display device of said presentation station to provide visual feedback of safety driving performance during an information presentation session.

2. The article as described in claim 1 wherein the data generated during operation of the vehicle is one of: a total distance, an overspeed violation defined by a speed zone limit, a duration of time of seatbelt usage compliance, an engine speed over revving occurrence, a night driving occurrence, a harsh braking occurrence, and a harsh acceleration occurrence.

3. The article as described in claim 2 wherein said values corresponds to a time-period between leading up an information presentation session.

4. The article as described in claim 1, further comprising: a Radio Frequency ID (RFID) card, said presentation station requiring said vehicle operator to authenticate using said RFID card prior to beginning an said information presentation session.

5. The article as described in claim 4, further comprising a dual chip card reader, wherein said presentation station requiring said vehicle operator to authenticate is occurs via said dual chip card reader.

6. The article as described in claim 2, further comprising: an animated FMS robot character graphically displayed on said graphical display device of said presentation station to provide additional visual feedback of safety driving performance during an information presentation session, wherein said control signals drive said animated FMS robot character's gestures to assist and inform the driver of said instance of unsafe behavior according to said value.

7. The article as described in claim 3 wherein said infographic is a meter.

8. The article as described in claim 7, further comprising program code that incrementally sums said values into a total representing points earned during said information presentation session, wherein said points earned are graphically displayed by said meter.

9. The article as described in claim 7, wherein said presentation station further comprises: a printing device; and program code that instructs the printer to print out a driving report receipt that includes information on the points earned during said information presentation session.

10. A presentation station for guiding an operator of a vehicle to operate a vehicle in accordance with a defined road safety policy, comprising:
a means for means for graphically providing visual feedback of values representing driving safety status information comprising: a total distance, an overspeed violation defined by exceeding a speed zone limit, a duration of time of seatbelt usage compliance, an engine speed over revving occurrence, a night driving occurrence, a harsh braking occurrence, and a harsh acceleration occurrence; wherein each value is weighed in proportion to a total distance driven during said operation of said vehicle, and wherein each said value further corresponds to a time-period between leading up an information presentation session;
a RFID card and a dual chip card reader for authentication prior to starting said information presentation session; and
wherein said visual feedback comprises an infographic meter and an animated FMS robot character graphically displayed on said graphical display device of said presentation station to provide feedback on safety driving performance during an information presentation session, wherein one or more control signals drive said animated FMS robot character's gestures to assist and inform the driver of any instance of unsafe behavior according to said value, and said infographic illustrates the total points earned; and wherein said presentation station comprises: a printing device print out a driving report receipt that includes information on the points earned during said information presentation session.
